(19) United States
(12) Patent Application Publication
(10) Pub. No.: US 2016/0352637 A1
(43) Pub. Date: Dec. 1, 2016

(54) CLIENT-BASED PORT FILTER TABLE

(71) Applicant: HEWLETT PACKARD ENTERPRISE DEVELOPMENT LP, Houston, TX (US)

(72) Inventors: Shaun Wakumoto, Roseville, CA (US); Craig Joseph Mills, Roseville, CA (US)

(73) Assignee: Hewlett-Packard Development Company, L.P., Houston, TX (US)

(21) Appl. No.: 15/117,497

(22) PCT Filed: Mar. 24, 2014
(86) PCT No.: PCT/US2014/031577

§ 371 Date: Aug. 9, 2016

(51) Int. Cl. H04L 12/741; H04L 29/12

(52) U.S. Cl. CPC H04L 45/745; H04L 61/6022; H04L 61/2007

(57) ABSTRACT

Example implementations relate to updating a client-based port filter table using a network device. For example, an apparatus may include a processor to receive a client device connection information message from a network switching device. The processor further to direct, via a configuration message, the network switching device to update a first entry of a client-based port filter table associated with a client device. The first entry includes an egress physical port set of the network switching device usable to output a packet sourced by the client device independent of a forwarding path of the packet.

### BACKGROUND

A network switch is a device that enables network communications among multiple client devices via a network protocol. For example, multiple client devices, such as desktop computers and server computers, may communicate to each other using at least one network switch.

### BRIEF DESCRIPTION OF THE DRAWINGS

Some examples of the present application are described with respect to the following figures:

FIG. 1 is a block diagram of an example network device for updating a client-based port filter table in a network switching device;

FIG. 2 is a block diagram of an example network including a network device to update client-based port filter tables in a network switching device;

FIG. 3 is a block diagram of the example network of FIG. 2 when a client device moves from a first network switching device to a second network switching device;

FIG. 4 is a diagram of an example client-based port filter table;

FIG. 5 is a flowchart illustrating an example method of restricting a communication path of a network device using a client-based port filter table; and

FIG. 6 is a flowchart illustrating an example method of updating a client-based port filter table.

### DETAILED DESCRIPTION

As described above, multiple client devices may communicate to each other using at least one network switch. When secured communication is needed, such as sensitive communications from a first client device to a server via an uplink, a private virtual local area network (PVLAN) may be used to provide a secured and isolated communication path between the two devices. However, the use of PVLAN reduces the set of VLANs available to the network as VLAN identifiers are used for isolation rather than for normal network usage, such as routing packets.

Examples described herein address the above challenges by providing a network device that can dynamically update a client-based port filter table in a network switching device. For example, a network device, such as a software-defined networking (SDN) controller, may be coupled to a plurality of network switching devices. Each network switching device may be coupled to at least one client device. Each network switching device may restrict packets generated by a particular client device to at least one physical egress port on the respective network switch device by using a corresponding client-based port filter table. The SDN controller may dynamically set and/or update each client-based port filter table based on changes in network topology, such as movements of client devices from one network switching device to another network switching device. In this manner, examples described herein may increase the set of VLANs available to the network. Further, examples described herein may reduce network management complexity.

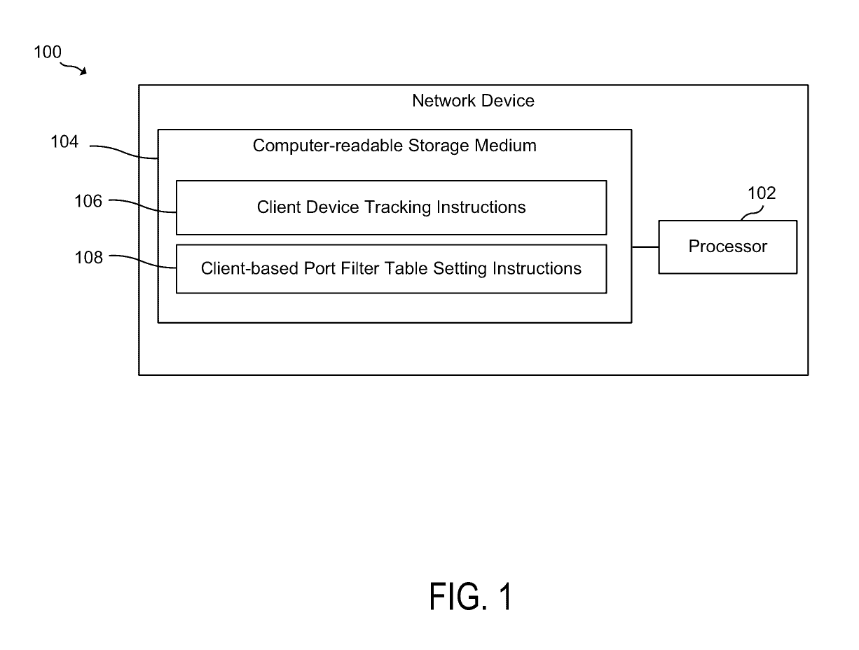

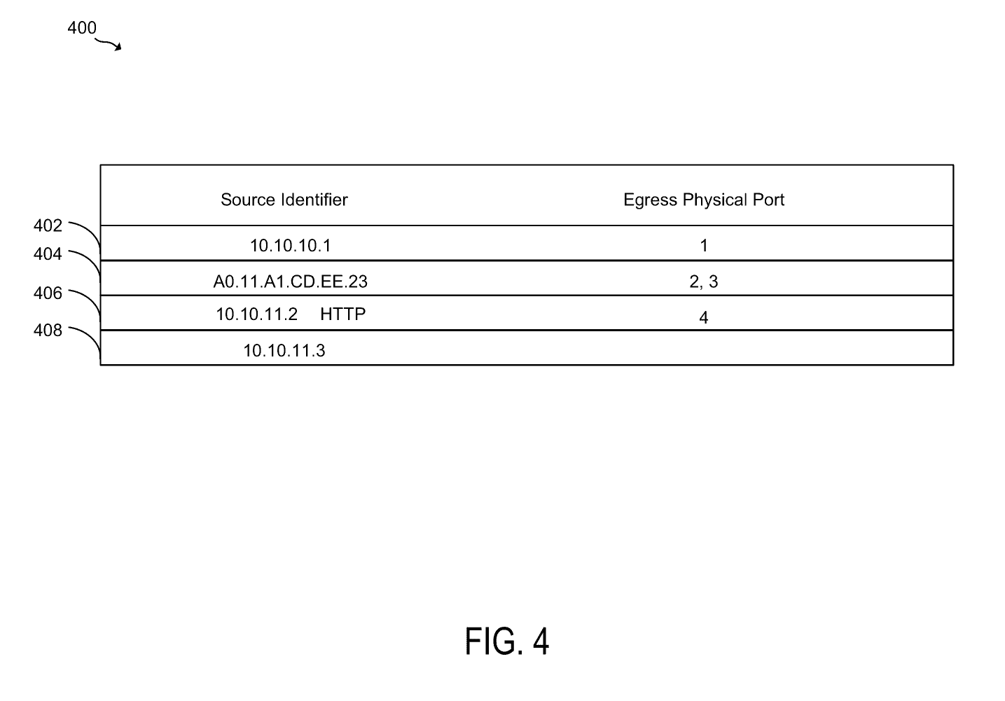

Referring now to the figures, FIG. 1 is a block diagram of an example network device 100 for updating a client-based port filter table in a network switching device. As used herein, a network switching device may a device that is suitable to connect multiple devices on a network. For example, a network switching device may be a network switch or a network router. As used herein, a client-based port filter table may be a data structure that identifies at least one physical port on a network switching device from which packets sourced/generated by a client device may egress the network switching device. A client-based port filter table is independent of a forwarding path of the packets (i.e., how the packets reach the destination). The packets may be routed or forwarded to a destination based on a forwarding path, such as defined in an OpenFlow table or a layer 2 media access control (MAC) address table. A client-based port filter table is used to determine whether the packets are allowed to egress a particular port of a network switching device. Examples of client-based port filter tables are described in more detail with reference to FIG. 4.

Network device 100 may be, for example, a desktop computer, a laptop computer, a local area network server, or any other electronic device suitable for updating a client-based port filter table in a network switching device. Network device 100 may include a processor 102 and a computer-readable storage medium 104.

Processor 102 may be a central processing unit (CPU), a semiconductor-based microprocessor, and/or other hardware devices suitable for retrieval and execution of instructions stored in computer-readable storage medium 104. Processor 102 may fetch, decode, and execute instructions 106 and 108 to control a process of updating client-based port filter tables in network switching devices. As an alternative or in addition to retrieving and executing instructions, processor 102 may include at least one electronic circuit that includes electronic components for performing the functionality of instructions 106, 108, or a combination thereof.

Computer-readable storage medium 104 may be any electronic, magnetic, optical, or other physical storage device that contains or stores executable instructions. Thus, computer-readable storage medium 104 may be, for example, Random Access Memory (RAM), an Electrically Erasable Programmable Read-Only Memory (EEPROM), a storage device, an optical disc, etc. In some examples, computer-readable storage medium 104 may be a non-transitory storage medium, where the term “non-transitory” does not encompass transitory propagating signals. As described in detail below, computer-readable storage medium 104 may be encoded with a series of processor executable instructions 106 and 108 for keeping track of client device movements and updating corresponding client-based port filter tables.

When network device 100 is implemented as a network controller, such as SDN controller, client device tracking instructions 106 may identify topology information of a network, such as the physical topology of the network and the logical topology of the network, and changes to the topologies. Client device tracking instructions 106 may implement software defined networking (SDN), such as by implementing the network configuration (NetConf) protocol, an OpenFlow Config protocol, and/or a simple network management protocol (SNMP), to identify the topology information and changes to the topologies. Client device tracking instructions 106 may also identify and track client devices coupled to each network switching device of the network by media access control (MAC) learning and/or implementing network access control (NAC).

Client-based port filter table setting instructions 108 may generate and transmit a configuration message based on a client device connection information message when network device 100 is implemented as a network controller, such as a SDN controller. A configuration message may direct a network switching device to update entries of a client-based port filter table.

When network device 100 is implemented as a network switching device, client device tracking instructions 106 may generate a client device connection information message based on detection of client devices coupled to network device 100. Client device tracking instructions 106 may also direct network device 100 to transmit the client device connection information message to a network controller. Client-based port filter table setting instructions 108 may set and/or update client-based port filter tables in each network switching device of the network based on changes to the topologies and/or movements of the client devices. For example, client-based port filter table setting instructions 108 may initially populate a corresponding client-based port filter table in each network switching device of the network based on client devices coupled to the network switching devices. Subsequently, based on changes to the topologies and/or movements of the client devices, client-based port filter table setting instructions 108 may update the corresponding client-based port filter tables via a configuration message received from a network controller.

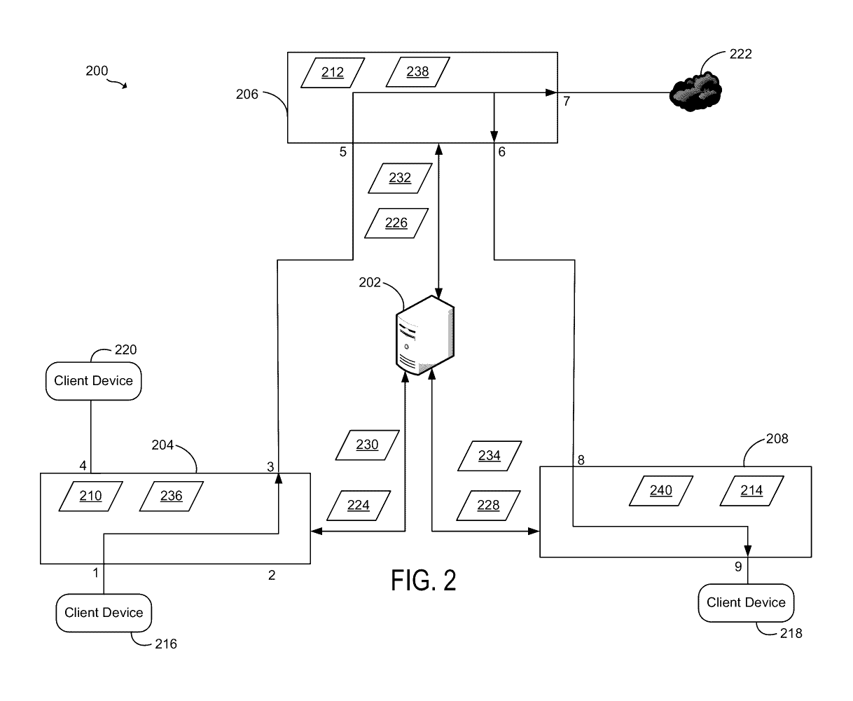

FIG. 2 is a block diagram of an example network 200 including a network device to update client-based port filter tables in a network switching device. Network 200 may be a local area network (LAN), a network implementing SDN, a network implementing the OpenFlow protocol, a wide area network (WAN), etc. In some examples, network 200 may be a network implementing SDN. In some examples, network 200 may be a network implementing the OpenFlow protocol. Network 200 may include a network device 202 and network switching devices 204-208. Network device 202 may be a desktop computer, a server computer, a smartphone, a tablet computer, or any computing devices suitable to control a network. In some examples, network device 202 may be implemented as an OpenFlow controller. In some examples, network device 202 may be implemented as a SDN controller. Each of network switching devices 204-208 may include a plurality of physical ports. As used herein, a physical port is a hardware interface that enables a client device to connect to a network switching device via a cable, such as a network cable. For example, a physical port may correspond to a physical layer (“layer 1”) port. A physical port is different from a logical port, such as a layer 2 port.

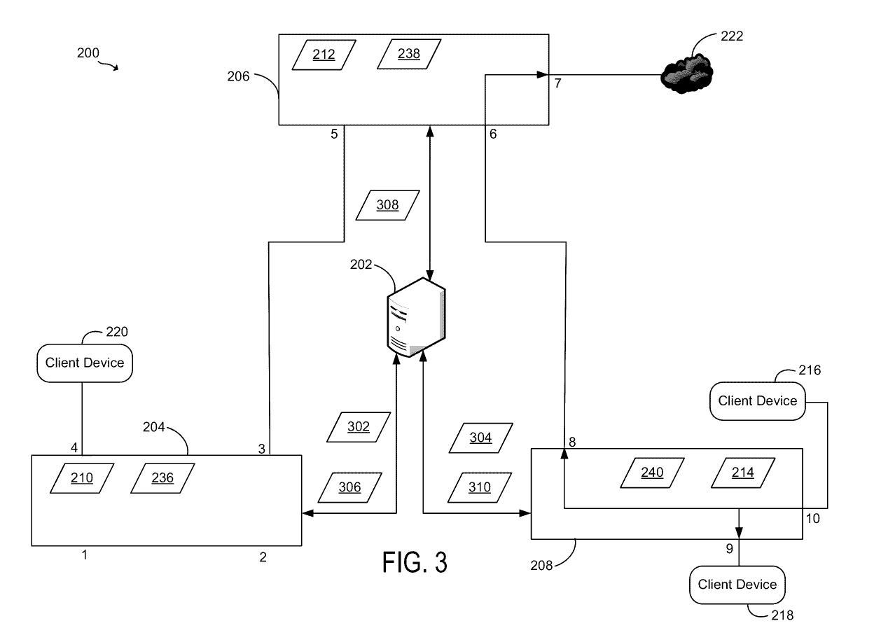

Each of network switching devices 204-208 may include a corresponding client-based port filter table 210-214, respectively. Each client-based port filter table 210-214 may be populated by network device 202 based on connection information of client devices of network 200. Each client-based port filter table 210-214 may include distinct entries associated with client devices 216-220. For example, client-based port filter table 210 may include a first entry that is associated with client device 216. Client-based port filter table 210 may also include a second entry that is associated with client device 218. Client-based port filter table 210 may further include a third entry that is associated with client device 220. Each entry may identify at least one physical egress port on network switching device 204 that is associated with a corresponding client device 216-220. Client-based port filter tables 212-214 may also include entries associated with client devices 216-220. For purpose of brevity and clarity, entries in client-based port filter tables 210-214 that are associated with client device 216 are described with reference to FIGS. 2-3. In some examples, network device 202 may include local copies of client-based port filter tables 210-214.

During operation, network device 202 may periodically receive client device connection information messages 224-228 from network switching devices 204-208, respectively. Client device connection information messages 224-228 may identify client devices that are connected to each network switching device 204-208, respectively. Based on any of client device connection information messages 224-228, network device 202 may generate configuration messages 230-234. Network device 202 may transmit configuration messages 230-234 to network switching devices 204-208 to set and/or update client-based port filter tables 210-214, respectively.

A network administrator may use any of client-based port filter table 210-214 to restrict an entity that a particular client device may communicate with. For example, a network administrator may set client-based port filter tables 210-214 via network device 202 such that client device 216 may transmit packets to client device 218 or to a network 222, but not to client device 220.

Based on client device connection information messages 224-228 and topology information obtained via implementation of SDN, network device 202 may configure network switches 204-208 via client-based port filter tables 210-214 to enable a communication path between network 222 and client device 216 and a communication path between client device 218 and client device 216. Packet forwarding decisions between client device 216 and network 222 and/or client device 216 and client device 218 may be performed via network forwarding rules, such as forwarding using MAC addresses and/or Internet protocol (IP) addresses.

Network device 202 may transmit configuration message 230 to network switching device 204 to set client-based port filter table 210 such that an entry associated with client device 216 in client-based port filter table 210 may identify the physical port 3 of network switching device 204 as an egress physical port of client device 216. Network device 202 may also transmit configuration message 232 to network switching device 206 to set client-based port filter table 212 such that an entry associated with client device 216 in client-based port filter table 212 may identify the physical ports 6-7 of network switching device 206 as egress physical ports of client device 216.

Network device 202 may further transmit configuration message 234 to network switching device 208 to set client-based port filter table 214 such that an entry associated with client device 216 in client-based port filter table 214 may identify the physical port 9 of network switching device 208 as an egress physical port of client device 216. In any of client-based port filter tables 210-214, client device 216 may be identified based on a source media access control (MAC) address of client device 216, a source Internet protocol (IP) address of client device 216, an application type, or a combination thereof.

When connections between interconnecting network switching devices change, network device 202 may use configuration messages 230-234 to update client-based port filter tables 210-214, respectively. For example, when a connection between network switching device 204 and network switching device 206 is changed from the physical port 3 of network switching device 204 to a physical port 2 of network switching device 204, network device 202 may use configuration message 230 to update client-based port filter table 210 such that the egress physical port of client device 216 is updated to the physical port 2.

When client device 216 transmits a first packet to network switching device 204, network switching device 204 may examine the first packet to identify a destination of the first packet based on a destination MAC address, a destination IP address, a VLAN identifier, etc. Based on the destination of the first packet, network switching device 204 may determine a forwarding path of the first packet. The forwarding path may indicate which network switching device and which port on a network switching device the first packet is to traverse through to reach the destination. Network switching device 204 may determine the forwarding path based on a forwarding table 236. Forwarding table 236 may include a routing table, a MAC address table, an OpenFlow table, etc. Network switches 206-208 may also include forwarding tables 236-240, respectively.

Based on the forwarding path, network switching device 204 may determine at least one output port of network switching device 204 from which the first packet is to be forwarded towards the destination. As an example, when the destination is client device 220, network switching device 204 may determine that an output port is a physical port 4 of network switching device 204. As another example, when the destination is client device 218 or network 222, network switching device 204 may determine that an output port is a physical port 3 of network switching device 204.

To determine whether client device 216 is permitted to transmit packets via the output port, network switching device 204 may compare the output port to an egress physical port set of client device 216 as identified in client-based port filter table 210. An egress physical port set may identify at least one egress physical port of a client device on a network switch. For example, an egress physical port set may identify at least one egress physical port of client device 216 on network switch 204. When the output port is not contained within the egress physical port set (e.g., the output port does not match any egress physical ports in the egress physical port set), network switching device 204 may drop the first packet. For example, when the destination is client device 220, network switching device 204 may drop the first packet as the output port is the physical port 4 of network switching device 204 and the egress physical port is the physical port 3 of network switching device 204.

When the output port matches an egress physical port in the egress physical port set, network switching device 204 may forward the first packet towards the destination via the output port. For example, when the destination is client device 218 or network 222, network switching device 204 may forward the first packet to network switching device 206 via the physical port 3 of network switching device 204 as the output port and the egress physical port are both the physical port 3 of network switching device 204.

When network switching device 206 receives the first packet via a physical port 5 of network switching device 206, network switching device 206 may determine a forwarding path of the first packet. Network switching device 206 may determine an output port based on the forwarding path. Network switching device 206 may also determine whether to drop or forward the first packet based on a comparison between the output port and an egress physical port set of client device 216 on network switching device 206. The egress physical port set may identify at least one egress physical port of client device 216 on network switching device 206.

For example, when the destination of the first packet is network 222, network switching device 206 may determine that the output port is a physical port 7 of network switching device 206. Network switching device 206 may forward the first packet to network 222 via the physical port 7 of network switching device 206 as the output port and an egress physical port in the egress physical port set of client device 216 are both the physical port 7.

As another example, when the destination is client device 218, network switching device 206 may determine that the output port is a physical port 6 of network switching device 206. Network switching device 206 may forward the first packet to network switching device 208 via the physical port 6 of network switching device 206 as the output port and an egress physical port in the egress physical port set of client device 216 are both the physical port 6. Network switching device 206 may drop the first packet when the output port is different than both of the egress physical ports of client device 216 on network switching device 206.

When network switching device 208 receives the first packet via a physical port 8 of network switching device 208, network switching device 208 may determine a forwarding path of the first packet and an output port based on the forwarding path. When the destination is client device 218, network switching device 208 may determine that the output port is the physical port 9 of network switching device 208. Network switching device 208 may forward the first packet to client device 218 as the output port and the egress physical port are both the physical port 9. Network switching device 208 may drop the first packet when the output port is not contained within the egress physical port set.

In some examples, a network administrator may use any of client-based port filter table 210-214 to restrict an entity and a type of packets that a particular client device may communicate with. For example, an entry associated with client device 216 in client-based port filter table 210 may identify at least one egress physical port of client device 216 and an application type of client device 216. The application type may correspond to a protocol type of packets sourced by client device 216, such as Hypertext Transfer Protocol (HTTP) packets, session initiation protocol (SIP) packets, file transfer protocol (FTP) packets, etc. Thus, network switching device 204 may forward particular packets sourced by client device 216 when the particular packets match the application type identified in client-based port filter table 210 and an output port of the particular packets match at least one egress physical port of client device 216.

In some examples, a network administrator may use any of client-based port filter table 210-214 to restrict a particular type of packets that is permitted to egress a particular port of a network switching device. For example, instead of associating client device 216 with the physical port 3 of network switching device 204 in client-based port filter table 210, the physical port 3 may be associated with HTTP packets independent of client devices in client-based port filter table 210. Thus, network switching device 204 may forward packets sourced by either client device 216 or client device 220 via the physical port 3 when the packets are of a type that matches the application type in client-based port filter table 210.

FIG. 3 is a block diagram of the example network 200 when a client device moves from a first network switching device to a second network switching device. Referring to FIG. 3, at a time subsequent to network device 202 setting client-based port filter tables 210-214, client device 216 may be disconnected from network switching device 204 and may be coupled to network switching device 208 via a physical port 10 of network switching device. In response to the movement of client device 216, network switching device 204 may transmit a client device connection information message 302 to network device 202 to inform network device 202 that client device 216 is no longer coupled to network switching device 204. Network switching device 208 may transmit a client device connection information message 304 to network device 202 to inform network device 202 that client device 216 is coupled to network switching device 208 via the physical port 10.

In response to client device connection information messages 302-304, network device 202 may generate configuration messages 306-310. Network device 202 may transmit configuration messages 306-310 to network switching devices 204-208 to update client-based port filter tables 210-214, respectively. Based on configuration message 306, network switching device 204 may update the entry associated with client device 216 such that the physical port 3 is not identified as an egress physical port of client device 216. For example, the physical port 3 may be removed from the entry associated with client device 216. Accordingly, network switching device 204 may not forward packets sourced by client device 216 via any physical ports of network switching device 204.

Based on configuration message 308, network switching device 206 may update client-based port filter table 212 such that the physical port 6 is not identified as an egress physical port of client device 216 and the physical port 7 is identified as an egress physical port of client device 216. Based on configuration message 310, network switching device 208 may update client-based port filter table 214 such that the physical ports 8 and 9 of network switching device 208 may be identified as egress physical ports of client device 216. Thus, client device 216 remains restricted to transmitting packets to network 222 and client device 218 after client device 216 moves from network switching device 204 to network switching device 208.

FIG. 4 is a diagram of an example client-based port filter table 400. Client-based port filter table 400 may include a plurality of entries 402-408. Each entry 402-410 may correspond to a particular client device and/or a particular application type that is permitted to egress through a particular physical port of a network switching device, such as any of network switching devices 204-208 in FIGS. 2-3.

Each client device may be identified by a source IP address of the client device, a MAC address of the client device, an application type of the client device, or a combination thereof. For example, in entry 402, a first client device, such as any of the client devices 216-220 in FIGS. 2-3, may be identified via an IP address of the first client device. Also in entry 402, a physical port 1 of a network switching device may be identified as an egress physical port of the first client device. In entry 404, a second client device may be identified via a MAC address of the second client device and physical ports 2-3 of the network switching device may be identified as egress physical ports of the second client device.

In entry 406, a third client device may be identified via an IP address of the third client device and an application type sourced by the third client device. Also, in entry 406, a physical port 4 of the network switching device may be identified as an egress physical port. Thus, the network switching device may forward HTTP packets sourced by the third client device via the physical port 4 when the HTTP packets have a forwarding path that includes the physical port 4. The network switching device may drop other types of packets, such as SIP packets, sourced by the third client device having a forwarding path that includes the physical port 4. In entry 408, a fourth client device may be identified via an IP address of the fourth client device. However, in entry 408, no physical port is identified as an egress physical port of the fourth client device. Thus, the network switching device may drop any packets sourced by the fourth client device.

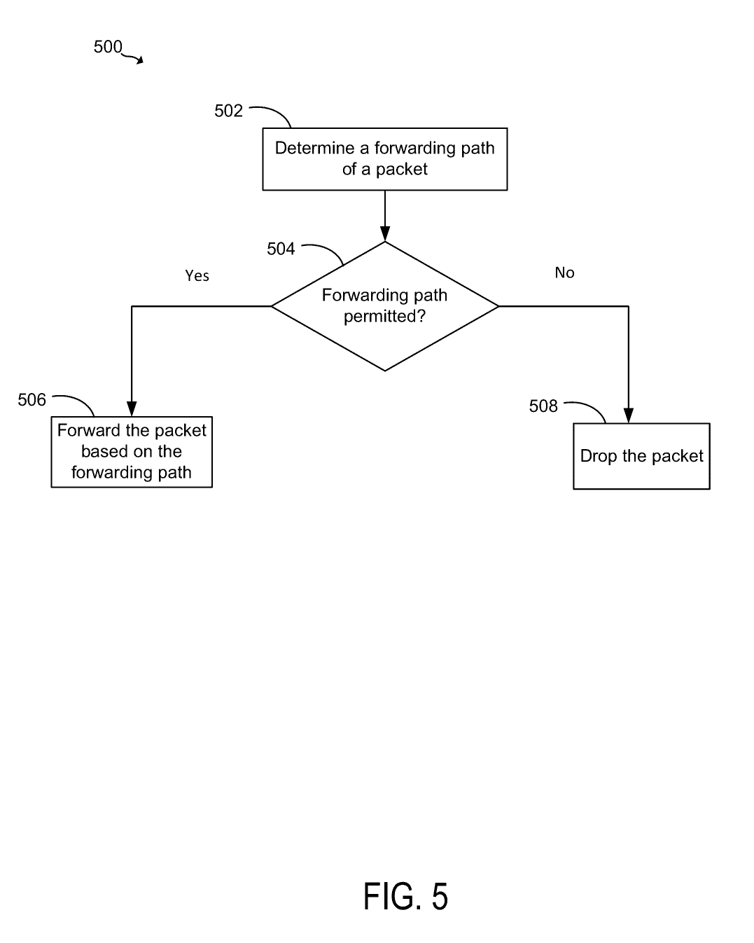

FIG. 5 is a flowchart illustrating an example method 500 of restricting a communication path of a network device using a client-based port filter table, such as client-based port filter table 210 of FIG. 2. Method 500 may be implemented by a network device, such as network switching device 204 of FIG. 2. Method 500 includes determining a forwarding path of a packet. At 502, network switching device 204 may determine a forwarding path of a packet received from a client device using a forwarding table, such as forwarding table 236. The forwarding path may include at least one output port of the packet on network switching device 204. At 504, network switching device 204 may determine whether the forwarding path is permitted by comparing the forwarding path to a client-based port filter table, such as client-based port filter table 210. For example, network switching device 204 may determine whether at least one output port matches at least one egress physical port of an egress physical port set identified in the client-based port filter table.

When at least one output port matches at least one egress physical port, network switching device 204 may forward the packet using the forwarding path (e.g., an output port), at 506. When there are no output ports contained within the egress physical port set, network switching device 204 may drop the packet, at 508.

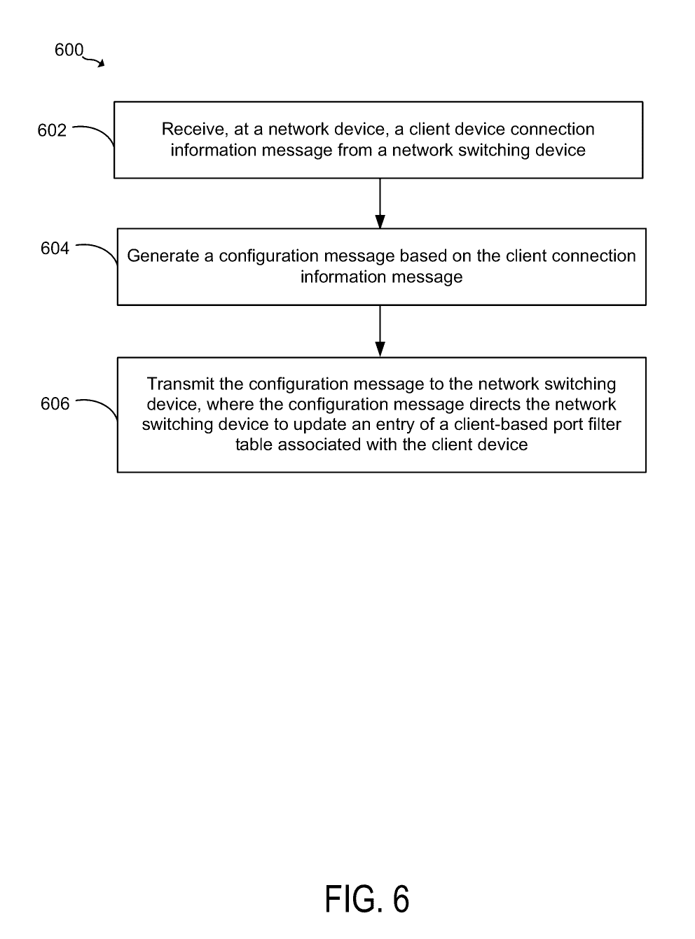

FIG. 6 is a flowchart illustrating an example method 600 of updating a client-based port filter table. Method 600 may be implemented by network device 202 of FIG. 2. Method 600 includes receiving, at a network device, a client device connection information message from a network switching device, at 602. For example, referring to FIG. 3, in response to the movement of client device 216, network switching device 204 may transmit client device connection information message 302 to network device 202 to inform network device 202 that client device 216 is no longer coupled to network switching device 204.

Method 600 also includes generating a configuration message based on the client connection information message, at 604. For example, referring to FIG. 3, in response to client device connection information messages 302-304, network device 202 may generate configuration messages 306-310.

Method 600 further includes transmitting the configuration message to the network switching device, where the configuration message directs the network switching device to update an entry of a client-based port filter table associated with the client device, at 606. For example, referring to FIG. 3, network device 202 may transmit configuration messages 306-310 to network switching devices 204-208 to update client-based port filter tables 210-214, respectively. Based on configuration message 306, network switching device 204 may update the entry associated with client device 216 such that the physical port 3 is not identified as an egress physical port of client device 216. Referring to FIG. 4, in entry 402, a first client device, such as any of the client devices 216-220 in FIGS. 2-3, may be identified via an IP address of the first client device. Also in entry 402, a physical port 1 of a network switching device may be identified as an egress physical port of the first client device.

The use of “comprising”, “including” or “having” are synonymous and variations thereof herein are meant to be inclusive or open-ended and do not exclude additional unrecited elements or method steps.

What is claimed is:

1. An apparatus comprising:
a processor to:
receive a client device connection information message from a network switching device; and
direct, via a configuration message, the network switching device to update an entry of a client-based port filter table associated with a client device, wherein the entry includes an egress physical port set of the network switching device usable to output a packet sourced by the client device independent of a forwarding path of the packet.

2. The apparatus of claim 1, wherein the entry further includes a source media access control (MAC) address of the client device, and wherein the egress physical port set includes at least one egress physical port.

3. The apparatus of claim 1, wherein the entry further includes a source Internet protocol (IP) address of the client device.

4. The apparatus of claim 1, wherein the entry further includes an application type of the client device.

5. The apparatus of claim 1, the processor further to direct, via a second configuration message, a second network switching device to update an entry of a second client-based port filter table associated with the client device.

6. The apparatus of claim 1, wherein the forwarding path to indicate an output port of the packet at the network switching device, wherein the network switching device to compare the output port to the egress physical port set, wherein the network switching device to drop the packet in response to a determination that the output port is not contained within the egress physical port set, wherein the network switching device to output the packet via the output port in response to a determination that the output matches the egress physical port, and wherein the configuration message is generated by a software-defined networking (SDN) controller.

7. The apparatus of claim 1, the processor further to:
receive second connection information of the client device from a second network switching device;
direct, via a second configuration message, the network switching device to update the entry of the client-based port filter table; and
direct, via a third configuration message, the second network switching device to update an entry of a second client-based port filter table.

8. A method comprising:
receiving, at a network device, a client device connection information message from a network switching device;
generating a configuration message based on the client connection information message; and
transmitting the configuration message to the network switching device, wherein the configuration message directs the network switching device to update an entry of a client-based port filter table associated with the client device, wherein the entry includes an egress physical port set of the network switching device usable to output a packet sourced by the client device independent of a forwarding path of the packet, and wherein the entry includes a source media access control (MAC) address associated with the egress physical port, a source Internet protocol (IP) address associated with the egress physical port, or a combination thereof.

9. The method of claim 8, wherein the network device is a software-defined network (SDN) controller.

10. The method of claim 8, wherein the forwarding path indicates an output port of the packet at the network switching device, wherein the network switching device to compare the output port to the egress physical port, wherein the network switching device to drop the packet when the output port is not contained within the egress physical port set, and wherein the network switching device to output the packet via the output port when the output matches the egress physical port.

11. The method of claim 8, further comprising directing, via a second configuration message, a second network switching device to update an entry of a second client-based port filter table associated with the client device.

12. The method of claim 8, further comprising:
receiving a second client device connection information message from a second network switching device;
directing, via a second configuration message, the network switching device to update the entry of the client-based port filter table; and
directing, via a third configuration message, the second network switching device to update an entry of a second client-based port filter table.

13. A computer-readable storage medium comprising instructions that when executed cause a controller of a network switching device to:
transmit a client device connection information message to a network device;
receive a configuration message from the network device; and
update an entry of a client-based port filter table associated with a client device based on the configuration message, wherein the entry includes an egress physical port set of the network switching device usable to output a packet sourced by the client device independent of a forwarding path of the packet, and wherein the entry includes an application type of the client device.

14. The computer-readable storage medium of claim 13, wherein the forwarding path to indicate an output port of the packet at the network switching device, wherein the instructions when executed further cause the controller to:
compare the output port to the egress physical port;
drop the packet in response to a determination that the output port is not contained within the egress physical port set; and
output the packet via the output port in response to a determination that the output matches the egress physical port.

15. The computer-readable storage medium of claim 13, wherein the network device is a software-defined network (SDN) controller.
